(19) United States
(12) Patent Application Publication
(10) Pub. No.: US 2007/0258655 A1
(43) Pub. Date: Nov. 8, 2007

(54) Method of adjusting image quality and apparatus operable to execute the same

(75) Inventor: Yoshihisa Motominami, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/707,481

(22) Filed: Feb. 15, 2007

(30) Foreign Application Priority Data
Feb. 15, 2006 (JP) P2006-037570

(51) Int. Cl. G06K 9/40

(52) U.S. Cl. 382/254

(57) ABSTRACT

In order to process motion image data including a plurality of frames, two or more frames are extracted from the frames as still image data. Image quality adjustment is performed with an identical adjustment condition for each of the extracted frames to obtain adjusted still image data.

### BACKGROUND

1. Technical Field

The present invention relates to a method of adjusting image quality and an apparatus operable to execute the same.

2. Related Art

There is an image processing apparatus for extracting still image data including a prescribed number of continuous frames from motion image data. Such a technology is disclosed in Japanese Patent Publication No. 2004-120638A (JP-A-2004-120638).

In addition, there is known a technology of analyzing contents of still image data and performing image quality adjustment with respect to the still image data according to characteristics of a still image.

As described above, when the still image data including the prescribed number of continuous frames is extracted from the motion image data, a plurality of extracted still images are simultaneously or continuously displayed or printed out.

In such a case, the still image data of the extracted frames may be subjected to an image quality adjustment. That is, the contents of the still image data are analyzed with respect to each of the prescribed number of extracted frame and the still image data is subjected to the image quality adjustment according to the characteristics of the still image.

In this case, since the data is originally the motion image data, a subject may be changed in the still images in the plurality of frames and thus different image quality adjustment conditions may be selected based on the result of the analyzing the contents of each still image data. For example, when a landscape is first captured and a person is then captured at the time of a motion image capturing, an image quality adjustment condition corresponding to the landscape is selected with respect to a frame of an initial part of the obtained motion image data and an image quality adjustment condition corresponding to the person is selected with respect to the frames from a middle part thereof.

However, when the different image quality adjustments are performed with respect to the still image data of the plurality of frames extracted from the motion image data and a plurality of still images based on the still image data of the plurality of frames are collectively displayed or printed out, a difference in color representation between the still images occurs and thus a user may feel discomfort.

### SUMMARY

It is therefore one advantageous aspect of the invention to provide a method of adjusting image quality and an apparatus operable to execute the same, which are capable of preventing a user from feeling discomfort due to an image quality adjustment of still images of a plurality of frames when still image data of a plurality of frames is extracted from motion image data and each frame of the still image data is subjected to the image quality adjustment..

According to one aspect of the invention, there is provided a method of processing motion image data comprised of a plurality of frames, comprising: extracting two or more frames from the frames as still image data; and performing image quality adjustment with an identical adjustment condition for each of the extracted frames to obtain adjusted still image data.

The method may further comprise: analyzing at least one of the extracted frames to obtain a quality characteristics thereof; and selecting the adjustment condition from a plurality of prescribed adjustment conditions in accordance with the obtained quality characteristics.

The first one of the extracted frames may be analyzed.

The method may further comprise selecting the at least one of the extracted frames in accordance with a command inputted from a user.

The at least one of the extracted frames may be at least one frame provided between the first one and the last one of the extracted frames.

At most all of the extracted frames may be analyzed. The method may further comprise: associating one of the adjustment conditions with each of the obtained quality characteristics; and selecting the one of the adjustment conditions which is associated with the extracted frames most frequently.

The adjustment conditions may include: a first condition suitable for a case where the still image data includes a person as a captured object; a second condition suitable for a case where the still image data includes a landscape as the captured object; and a third, general-purpose condition.

The method may further comprise: selecting the adjustment condition from a plurality of prescribed adjustment conditions. The adjustment conditions may include: a first condition suitable for a case where the still image data includes a person as a captured object; a second condition suitable for a case where the still image data includes a landscape as the captured object; and a third, general-purpose condition. The third condition may be selected as the adjustment condition.

The method may further comprise: designating a section in the motion image data in accordance with a command inputted from a user. The extracted frames may be arranged in the designated section at a fixed time interval.

The method may further comprise generating images of the extracted frames based on the adjusted still image data.

According to one aspect of the invention, there is provided a program product, comprising a medium storing a program operable to cause a computer to execute the above method.

According to one aspect of the invention, there is provided an apparatus operable to process motion image data comprised of a plurality of frames, comprising: an extractor, operable to extract two or more frames from the frames as still image data; and an image processor, operable to perform image quality adjustment with an identical adjustment condition for each of the extracted frames to obtain adjusted still image data.

### BRIEF DESCRIPTION OF THE DRAWINGS

FIG. 1 is a perspective view showing a printing apparatus according to one embodiment of the invention.

FIG. 2 is an enlarged plan view showing a control panel of the printing apparatus.

FIG. 3 is a block diagram showing an electric configuration of the printing apparatus.

FIG. 4 is a block diagram showing processors which are realized by executing a prescribed computer program by a CPU 41 shown in FIG. 3.

FIG. 5 is a flowchart illustrating the operation of the printing apparatus.

FIG. 6 is a view showing a display example of a display of the printing apparatus when a single frame printing is performed.

FIG. 7 is a view showing a display example of the display when an initial frame is selected in a multi-frame printing.

FIG. 8 is a view showing a display example of the display when a final frame is selected in the multi-frame printing.

FIG. 9 is a view showing a display example of the display when extracted still images are collectively displayed in the multi-frame printing.

FIG. 10 is a view showing a display example of the display when a chapter display mode is performed.

### DETAILED DESCRIPTION OF EXEMPLARY EMBODIMENTS

Exemplary embodiments of the invention will be described below in detail with reference to the accompanying drawings.

A printing apparatus according to one embodiment of the invention is operable to extract still image data including a prescribed number of frames from single motion image data in a motion image file and collectively printing a plurality of still images based on the plurality of still image data. The printing apparatus has a function of an image processing apparatus for performing an image quality adjustment with respect to the still image data including the prescribed number of frames extracted from the motion image data in the motion image file.

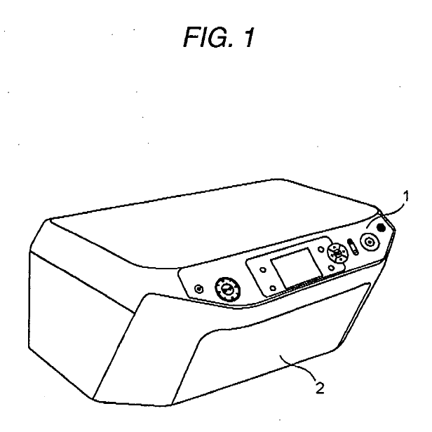

As shown in FIG. 1, the printing apparatus comprises a control panel 1 and a door cover 2 on a front face thereof. When the door cover 2 is opened, an ejection port (not shown) and a feeding port (not shown) appear.

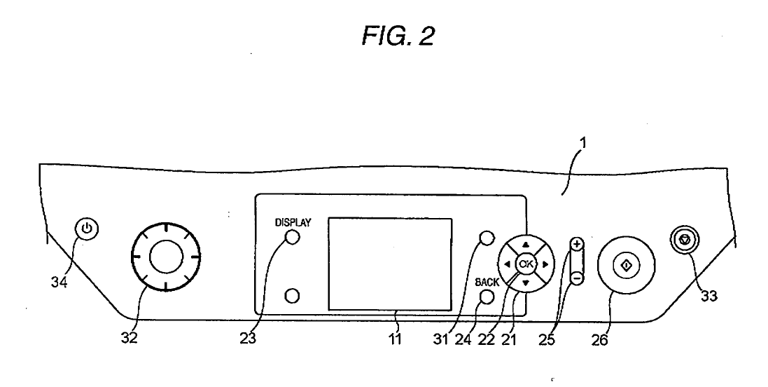

As shown in FIG. 2, the control panel 1 serves as a user interface and includes a display 11, and a cross key 21, an OK key 22, a display switching key 23, a back key 24, a number adjusting key 25, a start key 26, a print setting key 31, a mode switching key 32, a stop key 33 and a power key 34. Each of the above keys has an electric switch and a conduction state of the switch is changed when the switch is pressed by a user. The keys are operated when a variety of selections displayed on the display 11 is selected or a display state is changed.

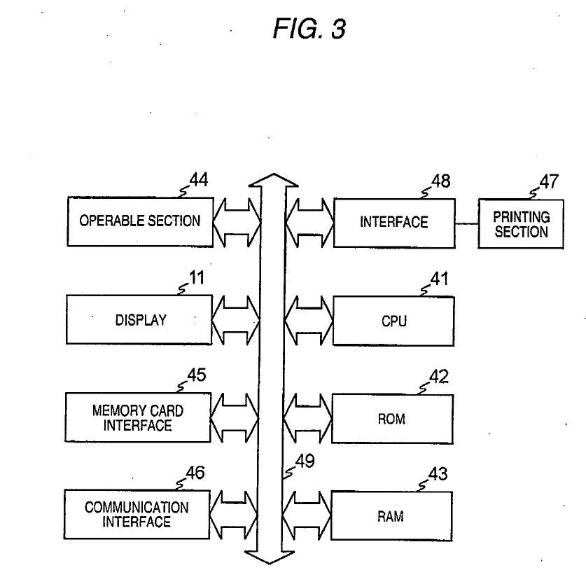

In FIG. 3, a CPU 41 is an arithmetic processor for executing a computer program to perform a process described in the computer program. A ROM 42 is a non-volatile memory such as a flash ROM for previously storing the computer program and data and is a recording medium. A RAM 43 is a memory for temporarily storing the program and data when executing the computer program.

The display 11 is a display device such as a liquid crystal display having a size of about 1.5 to 3.0 inches. An operable section 44 has a part for electrically detecting the user operation of the above-described keys.

A memory card interface 45 is an interface circuit for electrically connecting to a memory card (not shown) when the memory card is inserted. The memory card can be inserted into and extracted from the memory card interface 45. The memory card may be a SD card or a memory stick, and a motion image file including motion image data or a still image file including still image data is stored therein. The motion image file is a file including motion image data having a format of a variety of moving picture experts group (MPEG) or an H.264.

A communication interface 46 is an interface circuit for connecting equipments such as a personal computer or a digital camera through a cable or wireless communication and receiving the motion image file or the still image file. The communication interface 46 is based on a wired or wireless communication standard such as a universal serial bus (USB), Bluetooth or infrared-ray communication.

A printing section 47 has a printing head for ejecting ink, a feeding/ejecting motor and a sensor for sensing the position of a printing sheet or the printing head, so that an image is printed onto the printing sheet.

An interface 48 is an interface circuit which is electrically connected to elements of the printing section 47 and supplies a control signal to the printing section 47 or acquires a sensor signal from the printing section 47.

A bus 49 is a path for connecting the CPU 41, the ROM 42, the RAM 43, the operable section 44, the display 11, the memory card interface 45, the communication interface 46 and the interface 48 with one another. The CPU 41 communicates data with the operable section 44, the display 11, the memory card interface 45, the communication interface 46 and the interface 48 by way of the bus 49. The form of the bus 49 is not limited to that shown in FIG. 3.

A large-scale data storage device for storing the motion image file or the still image file may be connected to the bus 49 and used instead of or together with the memory card interface 45 and the memory card. Such a large-scale data storage device may be a hard disc drive or a disc driver into which an optical disc media is inserted.

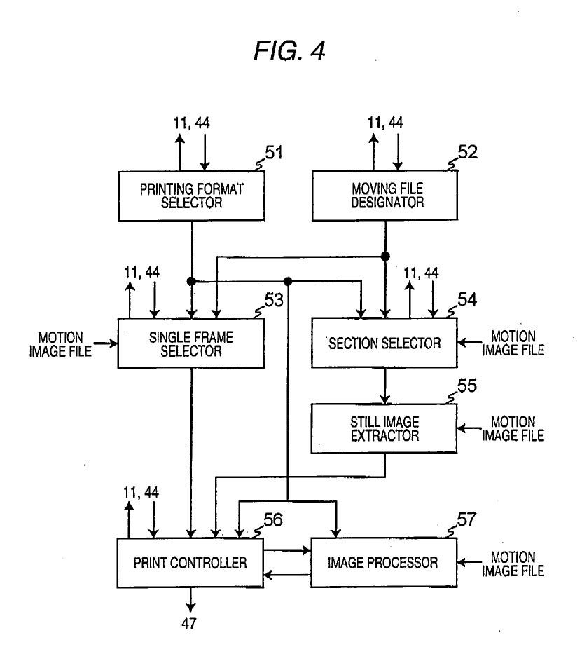

When the CPU loads and executes the computer program stored in the ROM 42, the processors having a variety of functions are realized as shown in FIG. 4.

In FIG. 4, a printing format selector 51 is a processor for selecting any one of a “single frame printing” for printing only a still image of single frame of a motion image in a motion image file and a “multi-frame printing” for printing a plurality of still image corresponding to a prescribed number of frames in a prescribed section of a motion image. The printing format selector 51 displays a menu image on the display 11 and selects the printing method based on the user operation of the operable section 44.

A motion image file designator 52 is a processor for designating a motion image file which is an extraction source of a still image to be printed. For example, the motion image file designator 52 displays a list of one or a plurality of motion image files stored in the memory card connected to the memory card interface 45 on the display 11 and selects one motion image file based on the user operation of the operable section 44.

A single frame selector 53 is a processor for extracting still image data of single frame from the motion image data in the motion image file, in the “single frame printing”. The single frame selector 53 extracts the still image data located at a designated point based on the motion image data in the motion image file, displays an image indicating the designated point in the entire length of the motion image and the still image based on the extracted still image data on the display 11, and changes the designated point of the still image to be extracted or decides the extracted still image data based on the user operation of the operable section 44.

A section selector 54 is a processor for selecting a motion image section for extracting the still image data of a plurality of frames from the motion image data in the motion image file, in the “multi-frame printing”. The section selector 54 extracts the still image data located at a designated point based on the motion image data in the motion image file. The section selector 54 displays: an image indicating the designated point in the entire length of the motion image; an image indicating a section start point in the entire length of the motion image; an image indicating a section end point in the entire length of the motion image; and the still image (or thumbnail image) based on the extracted still image data on the display 11. The section selector 54 changes the designated point of the still image to be extracted, sets the designated point to the section start point or the section end point, and decides a motion image section from which the still image data is to be extracted.

A still image extractor 55 is a processor for extracting the still image data including the prescribed number (in this embodiment, 12) of frames from the motion image section selected by the section selector 54. The still image extractor 55 designates intermediate frames existing between the section start point and the section end point selected by the section selector 54 and arranged at an equal time interval. The still image extractor 55 extracts the still image data of the frame of the section start point, the frame of the section end point and the intermediate frames from the motion image data in the motion image file. That is, the still image extractor 55 extracts a part of all frames constituting the motion image, that is, the prescribed number of frames located at an equal time interval.

A print controller 56 is a processor for performing an image printing based on the still image data of single frame extracted by the single frame selector 53 and based on the still image data of the plurality of frames extracted by the still image extractor 55. The print controller 56 controls the printing section 47 through the interface 48 while using an image processor 57 and performs the printing to print an image onto a printing sheet in this embodiment, the print controller 56 prints a plurality of images based on the still image data of the plurality of frames extracted by the still image extractor 55 on the printing sheets.

The image processor 57 is a processor for performing image processing such as an image quality adjustment, a color conversion and a halftoning with respect to the still image data of single frame extracted by the single frame selector 53 and the still image data of the plurality of frames extracted by the still image extractor 55.

The image processor 57 performs the same image quality adjustment condition with respect to the plurality of still image data in the image quality adjustment of the still image data of the plurality of frames extracted by the still image extractor 55. As the image quality adjustment condition, there are at least three patterns including “person”, “landscape” and “standard”.

As the image processing of the image processor 57, for example, an apparatus disclosed in Japanese Patent Publication No. 2002-344989A (JP-A-2002-344989) may be used.

In the image quality adjustment, the image processor 57 analyzes the still image data to acquire an image statistic value (characteristic parameter value) indicating the characteristics of the still image data and determines an automatic image quality adjustment parameter based on a difference between a prescribed reference parameter value and the image statistic value. The image processor 57 adjusts the image quality of the image data based on the automatic image quality adjustment parameter. The automatic image quality adjustment parameter includes parameters such as shadow, highlight, brightness, contrast, color balance, memory color and so on.

The image processor 57 performs the image quality adjustment using tone curves (S curves) for enabling correspondences between input levels and output levels of RGB components, with respect to the automatic image quality adjustment parameters such as the shadow, the highlight, the brightness, the contrast, the color balance and the memory color correction. When the image quality is adjusted using the tone curve, the tone curves of the RGB components are changed using the values of the automatic image quality adjustment parameters and the RGB components of the still image data are corrected using the changed tone curves of the RGB components. Accordingly, the still image data of which the image quality is adjusted is obtained.

The image quality adjustment based on the automatic image quality adjustment parameters are performed according to the condition of the image quality adjustment. With respect to contrast, the shadow and the highlight, a shadow point and a highlight point are detected from the still image data and all the levels are corrected based on the values of the shadow point and the highlight point. The tone curves are corrected based on a brightness standard deviation.

With respect to the brightness, it is determined whether the image is dark (insufficient exposure) or bright (excessive exposure) based on the brightness value calculated from areas obtained by dividing the still image data by 14 and the tone curves are corrected according to the determined result. With respect to the color balance, deflection of the color balance is analyzed from a histogram of the RGB components of the still image data and the tone curves of the RGB components are corrected. Accordingly, color fogging decreases.

With respect to chroma, a chroma distribution of the still image data is analyzed and thus the chroma is emphasized according to the chroma distribution. Accordingly, as the chroma of the still image data decreases, the level of the chroma emphasis increases.

With respect to sharpness, different unsharping masks are used in the landscape having a high spatial frequency and the person having a low spatial frequency.

With respect to the memory color, images corresponding to “flesh color” (corresponding to the “person”), “green” (corresponding to “landscape”), “sky blue” (corresponding to “landscape”), “sunset red” (corresponding to “landscape”) called the memory color are extracted from the still image data and corrected to become a preferred colors as the memory color.

In the color conversion, color spaces of the still image data after the image quality adjustment are converted into CMYK color spaces and converted into the color spaces corresponding to the types of the inks used for printing. In the halftoning, the number of gradations of the still image data after the color conversion is changed. For example, the still image data after the color conversion becomes data of 256 gradations for each color. Meanwhile, since data of two gradations indicating existence of the dot upon printing is used at the time of printing, the gradation is changed. As the method of changing the gradation, there is an error diffusion method or an ordered dither method.

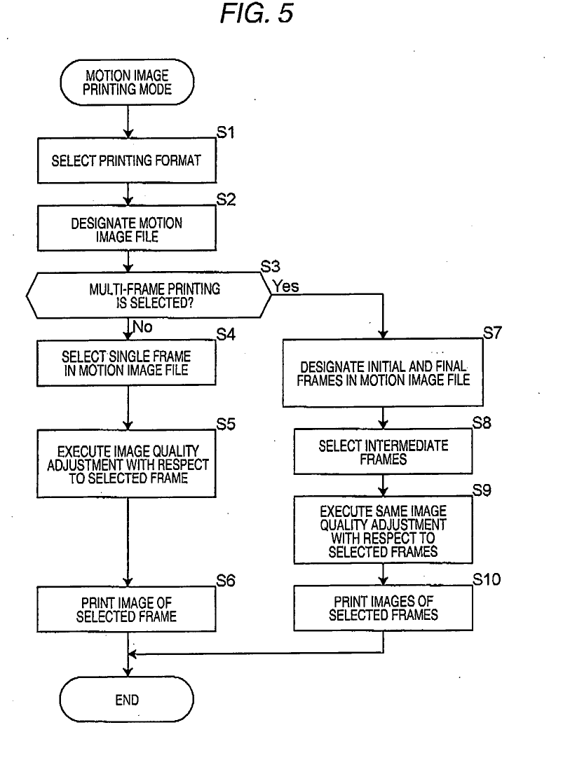

Next, the operation of the apparatus will be described with reference to FIG. 5.

When a motion image printing mode for printing the still image in the motion image is effected, the CPU 41 loads and executes the prescribed computer program stored in the ROM 42. Accordingly, the processors shown in FIG. 4 are realized.

In the motion image printing mode, first, the printing format selector 51 displays the menu image including an item “single frame printing” and an item “multi-frame printing” on the display 11. Thereafter, the printing format selector 51 monitors the state of the operable section 44, waits for the user operation of the operable section 44, detects the selection of the user, and selects the printing method according to the selection (step S1).

Next, when the memory card is used as a storage storing the motion image file, the motion image file designator 52 acquires the list of the motion image files in the memory card through the memory card interface 45 and displays the list of the names of the motion image files or the like on the display 11. Thereafter, the motion image file designator 52 monitors the state of the operable section 44, waits for the user operation of the operable section 44, detects the selection of the user, and selects the motion image file according to the selection (step S2).

Then, it is determined whether the printing format selected in the step S1 is the “single frame printing” or the “multi-frame printing” (step S3).

When the selected printing format is the “single frame printing”, the single frame selector 53 selects and extracts the still image data of single frame to be printed (step S4) and the print controller 56 and the image processor 57 perform the image processing and the printing with respect to the selected still image data of single frame, respectively (steps S5 and S6).

Meanwhile, when the selected printing format is the “multi-frame printing”, the section selector 54 and the still image extractor 55 selects and extracts the still image data of the plurality of frames to be printed (steps S7 and S8) and the print controller 56 and the image processor 57 perform the image processing and the printing with respect to the selected still image data of the plurality of frames, respectively (step S9 and S10).

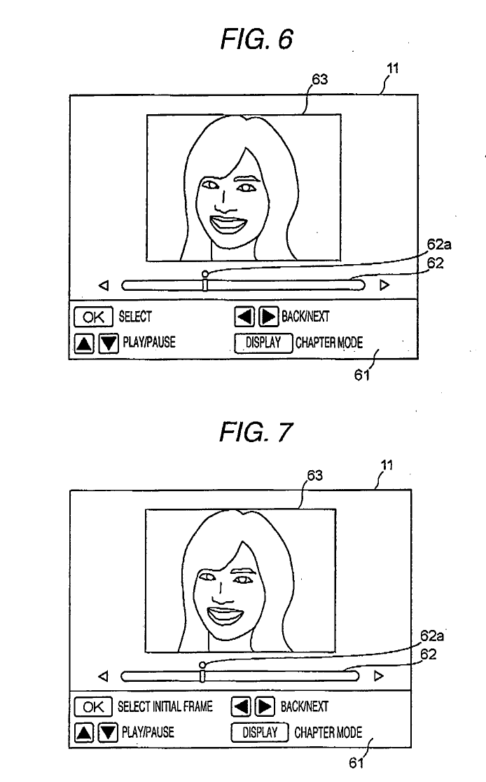

When the “single frame printing” is selected, the single frame selector 53 designates a first frame of the motion image file, and displays a help screen 61 showing the correspondence between the operable section 44 and the operation, and a slide bar image 62 indicating the designated point in the entire length of the motion image. In a display example shown in FIG. 6, the OK key 22 serves to determine a single frame to be printed, the left and right keys of the cross key 21 respectively serve to move the designated point backward and forward, and the upper and lower leys of the cross key 21 respectively serve to play the motion image from the designated point and pause the play of the motion image. The display switching key 23 serves to execute a display switching operation to a chapter display mode (described later). In the example shown in FIG. 6, the designated point is represented by a pointer image 62a of the slide bar image 62.

The single frame selector 53 extracts the still image data of the designated point based on the motion image data in the motion image file selected in the step S2 and displays the still image 63 based on the still image data on the display 11. Thereafter, the single frame selector 53 monitors the states of the OK key 22, the cross key 21 and the display switching key 23 displayed in the help screen 61, waits for the operation of the user, detects a pressing operation of a key by the user, performs the operation corresponding to the key, properly moves the designated point according to the operation, and finally determines that the frame of the designated point when the OK key 22 is pressed is the frame to be printed (step S4).

That is, when the right key of the cross key 21 is pressed, the single frame selector 53 continuously moves the display position of the pointer image 62a in the slide bar image 62 to the end point of the motion image during pressing, sets a display position of the pointer image 62a at a press completion time point to the designated point, extracts the still image data of the designated point, and displays the still image. When the left key of the cross key 21 is pressed, the single frame selector 53.continuously moves the display position of the pointer image 62a in the slide bar image 62 to the start point of the motion image during pressing, sets a display position of the pointer image 62a at a press completion time point to the designated point, extracts the still image data of the designated point, and displays the still image.

When the upper key of the cross key 21 is pressed, the single frame selector 53 reproduces the motion image of the designated point at that time point and displays the motion image on the display 11. At this time, the single frame selector 53 automatically moves the pointer image 62a to the end point of the motion image according to the reproduction position of the motion image. Thereafter, the lower key of the cross key 21 is pressed, the single frame selector 53 stops the reproduction of the motion image, displays the still image of the designated point at that time point on the display 11, and stops the movement of the pointer image 62a. Accordingly, the user can operate the operable section 44 while checking the image using the display 11 and move the designated point to a desired frame of the user. Thereafter, when the user presses the OK key 22, the frame of the designated point at that time point is decided to the frame to be printed. That is, the single frame selector 53 determines that the frame of the designated point at that time point is the frame to be printed and sets the still image data of that frame to the still image data of the frame to be printed.

When the frame to be printed is selected by the single frame selector 53, the print controller 56 controls the printing section 47 based on the data after the image processing and prints the image of single frame, while allowing the image processor 57 to perform the image processing with respect to the still image data of single frame. At this time, the image processor 57 selects an optimal image quality adjustment condition of the still image data of single frame and then performs the image quality adjustment (step S5), the color conversion and the halftoning at the condition for a prescribed number of lines. The print controller 56 generates a control signal for the printing section 47 based on the still image data after the image processing and the printing section 47 communicates the control signal and the sensor signal with the print controller 56 through the interface 48 and prints the image on a medium such as a printing sheet according to the control signal from the print controller 56 (step S6).

Now, the image quality adjustment will be described in detail. As described above, in the image quality adjustment of the image processor 57, there are at least modes for processing the “standard”, the “person” and the “landscape”.

The image processor 57 determines whether a subject is the person or the landscape by referring to the whole region of the selected still image data of single frame. In the determination, for example, a technology disclosed in Japanese Patent Publication No. 2006-107037A (JP-A-2006-107037) may be used.

In this technology, it is determined whether a face exists in the still image as the determination as to whether the subject is the person. With respect to the determination as to whether the face exists in the still image, ranges of RGB values corresponding to the skin color are previously set, a region (skin color region) having a color in the ranges of the RGB values is detected, positions having low brightness in the skin color region are considered as two eyes and a mouth, and it is determined that the face exists when the three positions satisfy a prescribed condition.

With respect to the determination as to whether the subject is the landscape, ranges of RGB values corresponding to the sky blue are previously set, a region (sky blue region) having a color in the ranges of the RGB values is detected with respect to the still image in which the subject is not the person, and it is determined that the subject is the landscape having the sky when the sky blue region does not contact at least one side of the still image. In addition, ranges of RGB values corresponding to the green is previously set, a region (green region) having a color in the ranges of the RGB values is detected with respect to the still image in which the subject is not the person, and it is determined that the subject is the landscape having the green (mountain or leaves) when the green region does not contact at least one side of the still image.

The image processor 57 sets the mode of the image quality adjustment to the “person” when the subject is determined to the person, sets the mode of the image quality adjustment to the “landscape” when the subject is determined to the landscape, and sets the mode of the image quality adjustment to the “standard” when the subject is not determined to the person and the landscape.

In the “standard” mode, the image processor 57 performs the above-described image quality adjustment with respect to the still image data, on the basis of the image quality parameter values obtained from the still image data.

In the “person” mode, the image processor 57 performs the above-described image quality adjustment with respect to the whole still image data, and performs an image quality adjustment for changing the color of the skin color region to a preferable skin color and a unfocusing (unsharping) processing, on the basis of the image quality parameter values obtained from the still image data.

In the “landscape” mode, the image processor 57 performs the above-described image quality adjustment with respect to the whole still image data, performs an image quality adjustment for changing the color of the sky blue region to a prescribed good sky blue when the subject is the landscape having the sky, and performs an image quality adjustment for changing the color of the green color to a prescribed good green when the subject is the landscape having the green, on the basis of the image quality parameter values obtained from the still image data.

When the “multi-frame printing” is selected, the section selector 54 designate a first frame of the motion image file, and displays the help screen 61 indicating the correspondence between the operable section 44 and the operation, and the slide bar image 62 indicating the designated point in the entire length of the motion image. In the example of the help screen 61 shown in FIG. 7, the OK key 22 serves to determine an initial frame of a motion image section to be printed, the left and right keys of the cross key 21 respectively serve to move the designated point backward and forward, and the upper and lower leys of the cross key 21 respectively serve to play a motion image from the designated point and to pause the play of the motion image. The display switching key 23 serves to execute a display switching operation to the chapter display mode (described later). In the example shown in FIG. 7, the designated point is represented by the pointer image 62a of the slide bar image 62.

The section selector 54 extracts the still image data of the designated point based on the motion image data in the motion image file selected in the step S2 and displays the still image 63 based on the still image data on the display 11. Thereafter, the section selector 54 monitors the states of the OK key 22, the cross key 21 and the display switching key 23 displayed in the help screen 61, waits for the operation of the user, detects a pressing operation of a key by the user, performs the operation corresponding to the key, properly moves the designated point according to the operation, and selects the frame of the designated point when pressing the OK key 22 as an initial frame (section start point) of the motion image section to be printed (step S7). In a time period from the start of the “multi-frame frame printing” to a time point when the section start point is determined, the operation of the section selector 54 when the cross key 21 is pressed is equal to that of the single frame selector 53 at the time of the “single frame printing”.

Accordingly, the point designated by the user becomes the initial frame of the motion image section to be printed. When the initial frame (section start point) of the motion image section to be printed is selected, an end frame (section end point) of the motion image section is selected.

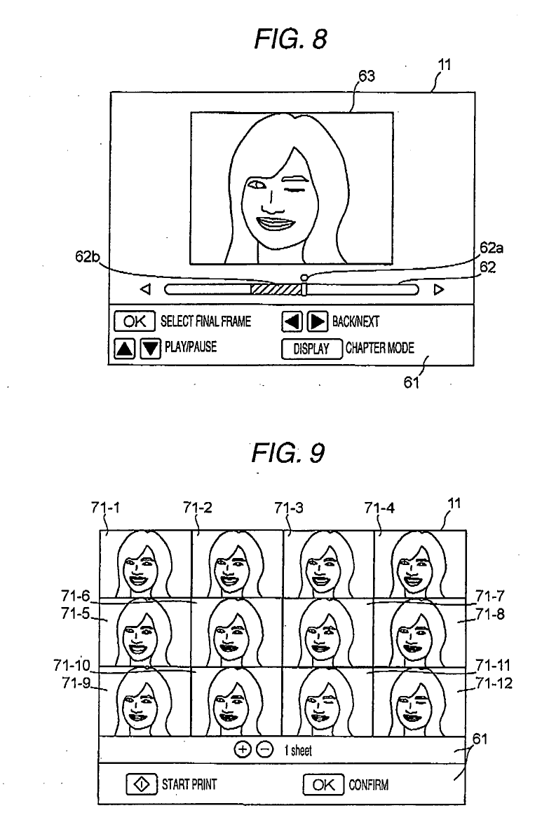

When the initial frame (section start point) of the motion image section to be printed is selected, the section selector 54 changes the help screen 61 displayed on the display 11. In the help screen after the change, as shown in FIG. 8, the OK key 22 serves to determine the end frame of the motion image section to be printed. The help screen 61 of the cross key 21 and the display switching key 23 and the operations corresponding to the keys are not changed.

Thereafter, the section selector 54 monitors the states of the OK key 22, the cross key 21 and the display switching key 23 displayed in the help screen 61, waits for the operation of the user, detects a pressing operation of a key by the user, performs the operation corresponding to the key, and properly moves the designated point according to the operation. When the designated point is moved, the display position of the pointer image 62a of the slide bar image 62 is moved. In a time period from a time point when the section start point is determined to a time point when the section end point is determined, a section 62b from a position of the pointer image 62a of the initial frame to a position of the pointer image 62a of the current time point is displayed in a color and/or a shape different from those of the other part of the slide bar. The section selector 54 selects the frame of the designated point when pressing the OK key 22 as the end frame (section end point) of the motion image section to be printed (step S7).

Accordingly, the point designated by the user becomes the end frame of the motion image section to be printed and thus the start point and the end point of the motion image section to be printed are determined by a series of operations.

When the start point and the end point of the motion image section to be printed are determined, the still image extractor 55 extracts the still image data including the prescribed number (in this embodiment, 12) of frames in the motion image section from the section initial frame to the section end frame selected by the section selector 54 from the motion image data.

At this time, the still image extractor 55 designates frames (intermediate frames) which must be extracted, in addition to the section start point and the section end point, based on the section start point, the section end point and necessary number of frames (number of still images to be printed).

For example, when the number of frames to be extracted is Nf, the frame number of the section initial frame is Fs, and the frame number of the section end frame is Fe, the frame is selected in every {(Fe-Fs)/(Nf-1)} frames from the section initial frame to the section end frame. At this time, the section initial frame and the section end frame are previously selected and the remaining (Nf-2) frames are selected. When the frame number becomes a real number by the calculation, the real number is changed to an integer by rounding down, rounding up or rounding off the value after a decimal point. As an example, when Nf=12, Fe=2 and Fs=1000, when rounding down the value after the decimal point, ten frames having the frame numbers 91, 182, 273, 364, 455, 545, 636, 727, 818 and 909 become the intermediate frames.

When the intermediate frames are designated, the still image extractor 55, the still image data of the frame of the section start point, the frame of the section end point and the intermediate frames from the motion image data in the motion image file.

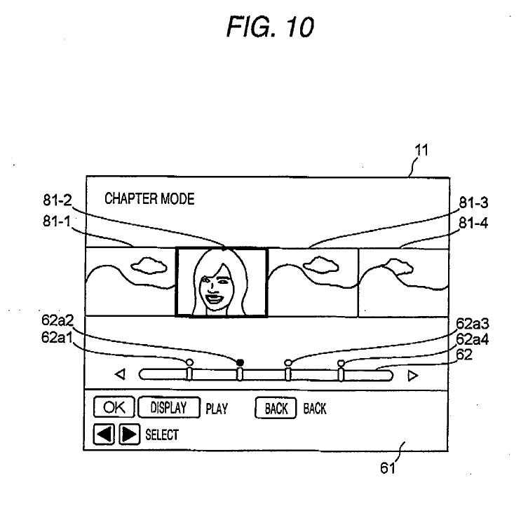

When the image data of the plurality of frames to be printed is extracted by the still image extractor 55, the print controller 56 arranges and displays the still images of the plurality of frames on the display 11 on the basis of the still image data of the plurality of frames. In FIG. 9, the still images 71-1 to 71-12 of 12 frames are displayed. In the help screen 61, the number adjusting key 25 and the start key 26 are displayed. The start key 26 serves to start a printing operation.

The print controller 56 controls the printing section 47 based on the data after the image processing and prints the image of the plurality of frames, while allowing the image processor 57 to perform the image processing with respect to the still image data of the plurality of frames. At this time, the image processor 57 performs the certain image quality adjustment (step S9) and performs the color conversion and the halftoning, with respect to the still image data of the plurality of frames. The printing section 47 transmits and receives the control signal and the sensor signal to and from the print controller 56 through the interface 48 and prints the image on a medium such as a printing sheet according to the control signal from the print controller 56 (step S10).

As described above, in the image quality adjustment of the image processor 57, there are at least modes for processing the “standard”, the “person” and the “landscape”. In the “multi-frame printing”, the image processor 57 performs the image quality adjustment with respect to the whole still image data of the plurality of frames by only one of these modes. That is, the image processor 57 designates the automatic image quality adjustment parameter values with respect to the still image data and performs the image quality adjustment in the certain processing modes.

The certain processing mode of the “multi-frame printing” is, for example, a prescribed default (for example, “standard”). In this case, the image processor 57 designates the automatic image quality adjustment parameter values and performs the image quality adjustment in the certain processing mode, without determining whether the subject is the person or the landscape with respect to the selected still images of the plurality of frames.

Alternatively, the certain processing mode of the “multi-frame printing” may be selected based on the user operation of the operable section 44 by the image processor 57.

Alternatively, the determination of the subject may be performed with respect to a part or all of the plurality of frames by the image processor 57 and the certain processing mode of the “multi-frame printing” may be determined based on the result of determination. In this case, the determination of the subject may be performed with respect to only a first frame of the plurality of frames and the certain processing mode may be determined based on the result of determination.

Alternatively, for example, the determination of the subject may be performed with respect to all the frames, and the processing mode when the processing mode is the same in all the frames or the processing mode having a largest number of frames may become the certain process mode of the “multi-frame printing” based on the result of determination. In a case where the determination of the subject is performed with respect to all the frames, the default processing mode may be selected when the number of same subject is less than a prescribed number.

Alternatively, for example, the determination of the subject is performed with respect to a central frame of the plurality of frames and the certain processing mode of the “multi-frame printing” may be determined based on the result of determination. In this case, the central frame is a frame located at the center when the plurality of frames is collectively printed. For example, when the printing is performed in the arrangement of the images 71-1 to 71-12 shown in FIG. 9, the frames of the images 71-6 and 71-7 become the central frame. When the number of the central frames is two instead of one, the determination of the subject is performed with respect to the two frames and the certain processing mode is determined based on the result of determination. When the processing modes of the two frames are equal, the processing mode is selected and, when the processing modes of the two frames are different, the default processing mode is selected.

With respect to the still image data of the plurality of frames, the image quality adjustment of the certain processing mode is performed and the plurality of still images is printed by a prescribed number of lines in a prescribed layout (for example, in the number of still images is 12, 12-up), while performing the remaining image processing.

The “multi-frame printing” for collectively printing the plurality of images which are located at a fixed interval in a designated section of the motion image is performed.

The chapter display mode is to set a virtual chapter obtained by dividing the entire length of the motion image data in the motion image file at a fixed interval, so that a motion image is reproduced and displayed for every chapter.

When the display switching key 23 is pressed in the states shown in FIGS. 6, 7 and 8, the single frame selector 53 or the section selector 54 switches the display of the display 11 to the chapter display mode shown in FIG. 10. Specifically, four chapters are set in addition to the top chapter of the motion image, the pointer images 62a1 to 62a4 are displayed at the top positions of the respective chapters in the slide bar image 62, and the images 81-1 to 814 of the initial frames in the respective chapters are displayed. The chapter which is being selected is changed by the left and right key of the cross key 21. With respect to the chapter which is being selected, the image 81-2 with a thick frame is displayed and the color of the pointer image 62a2 is different from that of the other pointer images. When the OK key 22 or the start key 26 is pressed, the state of the display returns to the original state shown in FIG. 6, 7 or 8 and the motion image reproduction from the top position of the chapter starts.

As described above, in this embodiment, the still image extractor 55 extracts the still image data of the plurality of frames from the motion image data and the image processor 57 performs the image quality adjustment of the same condition with respect to the still image data of the plurality of frames extracted by the still image extractor 55.

Since the image quality adjustment of the same condition is performed with respect to the still image data of the plurality of frames extracted from one motion image, it is possible to prevent the user from feeling discomfort due to the image quality adjustment although the plurality of still images extracted from one motion image is arranged after printing.

In this embodiment, the image processor 57 can perform the image quality adjustment in any one of a plurality of image quality adjustment conditions (here, three processing modes), selects any one from the plurality of image quality adjustment conditions based on image quality characteristics (here, automatic image quality adjustment parameter value) obtained by analyzing the still image data of any single frame of the still image data of the plurality of frames and performs the image quality adjustment of the same condition with the selected condition with respect to the whole still image data of the plurality of frames.

Accordingly, since only the still image data of single frame is analyzed in order to obtain the image quality characteristics, it is possible to select an adequate image quality adjustment condition with a small amount of calculation.

In this embodiment, the image processor 57 may select any one from the plurality of image quality adjustment conditions based on the image quality characteristics obtained by analyzing the still image data of a first frame of the still image data of the plurality of frames and perform the image quality adjustment of the same condition with the selected condition with respect to the whole still image data of the plurality of frames. In this case, since the still image of the first frame tends to be observed after being printed, the image quality adjustment condition suitable for the still image is selected and thus the more appropriate image quality adjustment condition can be selected with a small amount of calculation.

In this embodiment, the image processor 57 may select single frame from the plurality of frames based on the input to the operable section 44, select the image quality adjustment condition based on the image quality characteristics obtained by analyzing the still image data of the frame, and perform the image quality adjustment of the same condition with the selected condition with respect to the whole still image data of the plurality of frames. In this case, the image quality adjustment condition suitable for the image quality characteristics of the still image desired by the user is selected and thus the more appropriate image quality adjustment condition can be selected with a small amount of calculation.

In this embodiment, the image processor 57 may select the image quality adjustment condition based on the image quality characteristics obtained by analyzing the still image data of one central frame or two central frames of the still image data of the plurality of frames and perform the image quality adjustment of the same condition with the selected condition with respect to the whole still image data of the plurality of frames. In this case, when the motion image includes, for example, any operation such as a swing motion of golf from the start to the end thereof, since the image quality adjustment condition suitable for the central portion of the motion image is selected, the image quality adjustment condition suitable for the still image in which the motion is being performed is selected.

In this embodiment, the image processor 57 may analyze a part or all of the still image data of the plurality of frames, specify the image quality characteristics of each frame, specify the image quality adjustment condition of each frame corresponding to the image quality characteristics of each frame, and perform the image quality adjustment of the same condition with the image quality adjustment condition having a largest number of frames having the same condition with respect to the whole still image data of the plurality of frames. In this case, when the image quality adjustment condition is automatically selected, possibility of selecting an adequate image quality adjustment condition increases.

In this embodiment, the image processor 57 can perform the image quality adjustment with any one of a first image quality adjustment condition (here, “person” mode) when the subject is the person, a second image quality adjustment condition (here, “landscape” mode) when the subject is the landscape, and a third image quality adjustment condition (here, “standard” mode) when the subject is not defined, as the plurality of image quality adjustment conditions. Accordingly, since an adequate image quality adjustment is performed according to the type of the subject, it is possible to prevent the user from feeling discomfort due to the image quality adjustment.

In this embodiment, the image processor 57 performs the image quality adjustment of the same condition with the third image quality adjustment condition (here, “standard” mode) with respect to the whole still image data of the plurality of frames. Accordingly, even in any subject of the plurality of still images extracted from the motion image, since the image quality adjustment is performed with the condition suitable for the type of the subject, it is possible to prevent the user from being discomfort due to the image quality adjustment.

In this embodiment, the section selector 54 selects any section in the motion image data at the start point and the end point input to the operable section 44, the still image extractor 55 selects the plurality of frames such that the frame interval between the still images from the motion image data of the section selected by the section selector 54 becomes substantially uniform, and the image processor 57 performs the image quality adjustment with the same condition with respect to the still image data of the plurality of frames extracted by the still image extractor 55.

Accordingly, it is possible to simply select a desired section in the motion image data and to output a plurality of still images in the section while preventing the user from feeling discomfort due to the image quality adjustment.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

For example, a plurality of top frames (for example, two frames) may be analyzed and the mode of the image quality adjustment may be determined similar to the multi-frame printing mode.

In the above-described embodiment, a plurality of still images are printed based on the still image data of the plurality of frames after the image quality adjustment. Alternatively, the plurality of still images may be displayed on the display.

In the above-described embodiment, the still images of the plurality of frames are printed on one medium. Alternatively, the still images may be printed on a plurality of media or displayed on a plurality of screens.

In the above-described embodiment, among the processing modes such as the “person”, “landscape” and the “standard” in the “multi-frame printing”, a history or statistical data of the processing mode selected by the user may be stored in a storage (not shown) such as a flash memory so that a processing mode which is most frequently selected can be set to the certain processing mode or the default mode.

In the above-described embodiment, the selection menu indicating whether the image quality adjustment is performed or not may be displayed by the user interface of the operable section 44 and the display 11 before selecting a motion image file such that it is determined whether the image quality adjustment is performed or not by the print controller 56 according to the user operation. In this case, when the image quality adjustment is performed, the above-described processing is performed, and, when the image quality adjustment is not performed, the image quality adjustment is skipped.

The disclosure of Japanese Patent Application No. 2006-37570 filed Feb. 15, 2007 including specification, drawings and claims is incorporated herein by reference in its entirety.

What is claimed is:

1. A method of processing motion image data comprised of a plurality of frames, comprising:
extracting two or more frames from the frames as still image data; and
performing image quality adjustment with an identical adjustment condition for each of the extracted frames to obtain adjusted still image data.

2. The method as set forth in claim 1, further comprising:
analyzing at least one of the extracted frames to obtain a quality characteristics thereof; and
selecting the adjustment condition from a plurality of prescribed adjustment conditions in accordance with the obtained quality characteristics.

3. The method as set forth in claim 2, wherein:
the first one of the extracted frames is analyzed.

4. The method as set forth in claim 2, further comprising:.
selecting the at least one of the extracted frames in accordance with a command inputted from a user.

5. The method as set forth in claim 2, wherein:
the at least one of the extracted frames is at least one frame provided between the first one and the last one of the extracted frames.

6. The method as set forth in claim 2, wherein:
at most all of the extracted frames are analyzed; and
the method further comprises:
associating one of the adjustment conditions with each of the obtained quality characteristics; and
selecting the one of the adjustment conditions which is associated with the extracted frames most frequently.

7. The method as set forth in claim 2, wherein:
the adjustment conditions include:
a first condition suitable for a case where the still image data includes a person as a captured object;
a second condition suitable for a case where the still image data includes a landscape as the captured object; and
a third, general-purpose condition.

8. The method as set forth in claim 1, further comprising:
selecting the adjustment condition from a plurality of prescribed adjustment conditions, wherein:
the adjustment conditions include:
a first condition suitable for a case where the still image data includes a person as a captured object:
a second condition suitable for a case where the still image data includes a landscape as the captured object; and
a third, general-purpose condition; and
the third condition is selected as the adjustment condition.

9. The method as set forth in claim 1, further comprising:
designating a section in the motion image data in accordance with a command inputted from a user, wherein:
the extracted frames are arranged in the designated section at a fixed time interval.

10. The method as set forth in claim 1, further comprising:
generating images of the extracted frames based on the adjusted still image data.

11. A program product, comprising a medium storing a program operable to cause a computer to execute the method as set forth in claim 1.

12. An apparatus operable to process motion image data comprised of a plurality of frames, comprising:
an extractor, operable to extract two or more frames from the frames as still image data; and
an image processor, operable to perform image quality adjustment with an identical adjustment condition for each of the extracted frames to obtain adjusted still image data.
